(19) United States
(12) Patent Application Publication
(10) Pub. No.: US 2026/0177839 A1
(43) Pub. Date: Jun. 25, 2026

(54) LASER LIGHT SOURCE MODULE AND LASER COUPLING DEVICE THEREOF

(71) Applicant: IROYAL TECHNOLOGY CORPORATION, New Taipei City (TW)

(72) Inventors: CHING-HO HUANG, New Taipei City (TW); CHUNG-CHIEH HUANG, New Taipei City (TW); YUNG-PING CHIA, Taoyuan City (TW)

(21) Appl. No.: 19/218,524

(22) Filed: May 26, 2025

(30) Foreign Application Priority Data
Dec. 19, 2024 (TW) 113149742

(51) Int. Cl. G02B 27/09; G02B 19/00; G02B 27/12

(52) U.S. Cl. CPC G02B 27/0916; G02B 19/0009; G02B 19/0052; G02B 27/123

(57) ABSTRACT

A laser light source module includes a laser light source and a light concentrating element. A laser coupling device includes the laser light source module, a first optical transmission element, a light guide element, a second light concentrating element, and a second optical transmission element. The laser light source includes a base, a housing part, and a light-emitting part. The light-emitting part generate first laser beams. The first optical transmission element transmits second laser beams. The light guide element is disposed downstream of the first optical transmission element. The second light concentrating element is disposed downstream of optical paths of the light guide element and the first light concentrating element. The second optical transmission element is located downstream of an optical path of the second light concentrating element, and the second light concentrating element couples the first and second laser beams to the second optical transmission element.

### FIELD OF THE INVENTION

The present invention relates to a light source module, and in particular to a laser light source module and a laser coupling device thereof.

### BACKGROUND OF THE INVENTION

Laser beams feature high directivity and high brightness. Therefore, the use of the laser beams to illuminate an object can make edges of the object clearer without ghosting. As a result, an image generated by the laser beams is more detailed. In addition, because the laser beams can penetrate the human skin, the laser beams can also be used to obtain a clear image of subcutaneous tissue, which is quite helpful for medical image detection. With the advancement of science and technology and the development of the medical technology, the requirements for image definition are increasingly higher, and a laser coupling device can couple more than two laser beams to highlight a characteristic of an irradiated object by using characteristics of different laser beams.

### SUMMARY OF THE INVENTION

The present invention provides a laser light source module to improve light utilization efficiency.

The present invention provides a laser coupling device to improve light utilization efficiency and reduce a volume.

To achieve one, some, or all of the above objectives or other objects, an embodiment of the present invention provides a laser coupling device, including a laser light source module, a first optical transmission element, a first optical transmission element, a light guide element, a second light concentrating element, and a second optical transmission element. The first laser light source includes a base, a housing part, and a light-emitting part. The housing part is provided with a bottom end and a light outlet end opposite to each other. The bottom end is fixed to the base, and the light-emitting part is disposed on the base and is located in the housing part. The light-emitting part is suitable for generating first laser beams. The first light concentrating element is fixed to the light outlet end of the housing part or the base and located on a transmission path of the first laser beams. The first optical transmission element is suitable for transmitting second laser beams. The light guide element is disposed downstream of an optical path of the first optical transmission element. The second light concentrating element is disposed downstream of optical paths of the light guide element and the first light concentrating element. The second optical transmission element is located downstream of an optical path of the second light concentrating element, and the second light concentrating element is suitable for coupling the first laser beams and the second laser beams to the second optical transmission element.

In an embodiment of the present invention, the first light concentrating element includes, for example, a biconvex aspheric lens.

In an embodiment of the present invention, the laser coupling device further includes a housing, an optical transmission base, and a calibration component. The housing is provided with a first side, a second side, and a light outlet side. The first side is opposite to the light outlet side, and the second side is located between the first side and the light outlet side. The first laser light source is fixed to the first side. The optical transmission base is provided with an optical transmission part and a locking part connected to each other. The locking part is connected to the second side, and the optical transmission part is connected to the locking part and the first optical transmission element. The calibration component includes a plurality of locking components and a pad. The pad is pressed against a position between the second side and the locking part, and the locking component passes through the locking part and the pad and extends into the second side.

In an embodiment of the present invention, the pad includes, for example, a gasket.

In an embodiment of the present invention, the gasket is made of rubber, silicone, or metal.

In an embodiment of the present invention, the pad includes, for example, a plurality of pad rings.

In an embodiment of the present invention, the second side of the housing may be provided with a plurality of grooves. The pad rings are disposed in the grooves respectively, and a local part of each pad protrudes from each groove. The locking part is pressed against the local part of the pad rings.

In an embodiment of the present invention, the pad rings may be made of rubber, silicone, or metal.

In an embodiment of the present invention, there may be at least four locking components.

In an embodiment of the present invention, the light guide element includes, for example, a prism.

In an embodiment of the present invention, the first laser light source may include a white laser light source.

In an embodiment of the present invention, the laser coupling device may further include a light homogenizer, and the light homogenizer is disposed between the second light concentrating element and the second optical transmission element.

In an embodiment of the present invention, the first light concentrating element is fixed to the base and covers the light-emitting part. The first laser light source may further include a laser light source part, and the laser light source part is fixed to the base and is suitable for emitting laser beams to the first light concentrating element. The first light concentrating element is suitable for converging the first laser beams to the light-emitting part, and the light-emitting part is suitable for converting the laser beams into first laser beams.

To achieve one, some, or all of the above objectives or other objects, an embodiment of the present invention provides a laser light source module, including the aforementioned first laser light source and the first light concentrating element.

The first light concentrating element is used for the laser light source module in the present invention to focus the first laser beams generated by the first laser light source. The first light concentrating element is fixed to the light outlet end of the housing part of the first laser light source, to significantly shorten a distance of transmission of the first laser beams from the first laser light source to the first light concentrating element. Therefore, the laser light source module in the present invention can reduce energy loss of the first laser beams, thereby improving light utilization efficiency. The laser light source module is used for the laser coupling device in the present invention, so that the light utilization efficiency can be improved. In addition, because the first light concentrating element is fixed to the housing part of the first laser light source and is not separated from the first laser light source, space required for configuring the first light concentrating element can be significantly reduced, and then a volume of the laser coupling device can be effectively reduced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a laser coupling device according to an embodiment of the present invention;

FIG. 2 is a schematic diagram of a laser light source module in FIG. 1;

FIG. 3 is a schematic local cross-sectional diagram of the laser light source module in FIG. 2;

FIG. 4 is a schematic cross-sectional diagram of the laser coupling device according to another embodiment of the present invention;

FIG. 5 is a schematic diagram of the laser coupling device according to still another embodiment of the present invention;

FIG. 6 is a schematic diagram of separation of a first laser light source from a housing in FIG. 5;

FIG. 7 is a schematic exploded diagram of the laser coupling device in FIG. 5 without the first laser light source;

FIG. 8 is a schematic diagram of the laser coupling device according to still another embodiment of the present invention;

FIG. 9 is a schematic diagram of separation of the housing, an optical transmission base, a calibration component, and a first optical transmission element in FIG. 8;

FIG. 10 is a schematic diagram of separation of the housing, the optical transmission base, the calibration component, and the first optical transmission element of the laser coupling device according to another embodiment of the present invention;

FIG. 11 is a schematic partial cross-sectional diagram of assembly of the housing, the optical transmission base, and the calibration component in FIG. 10;

FIG. 12 is a schematic diagram of the laser coupling device according to still another embodiment of the present invention; and

FIG. 13 is a schematic partial cross-sectional diagram of the laser light source module of the laser coupling device according to another embodiment of the present invention.

### DETAILED DESCRIPTION OF PREFERRED EMBODIMENTS

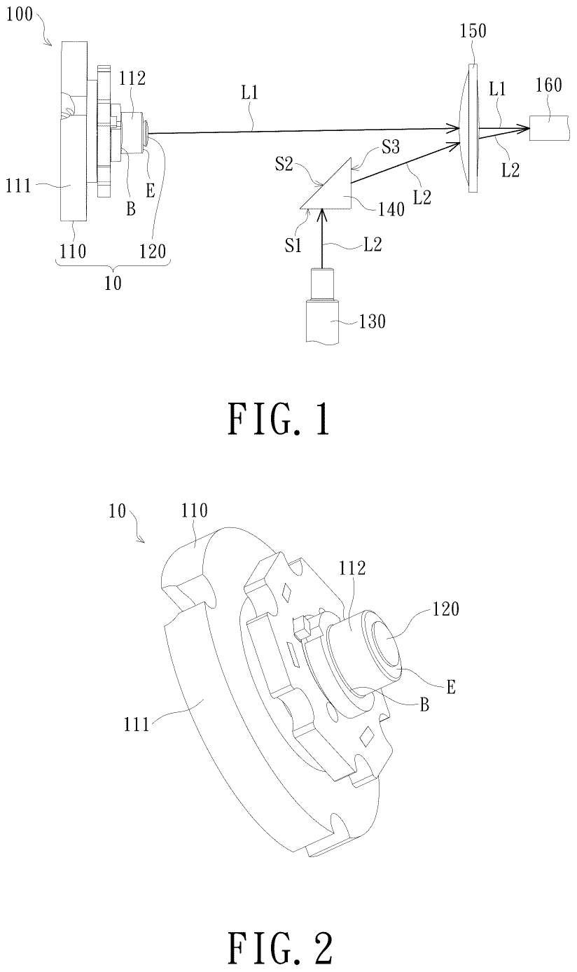

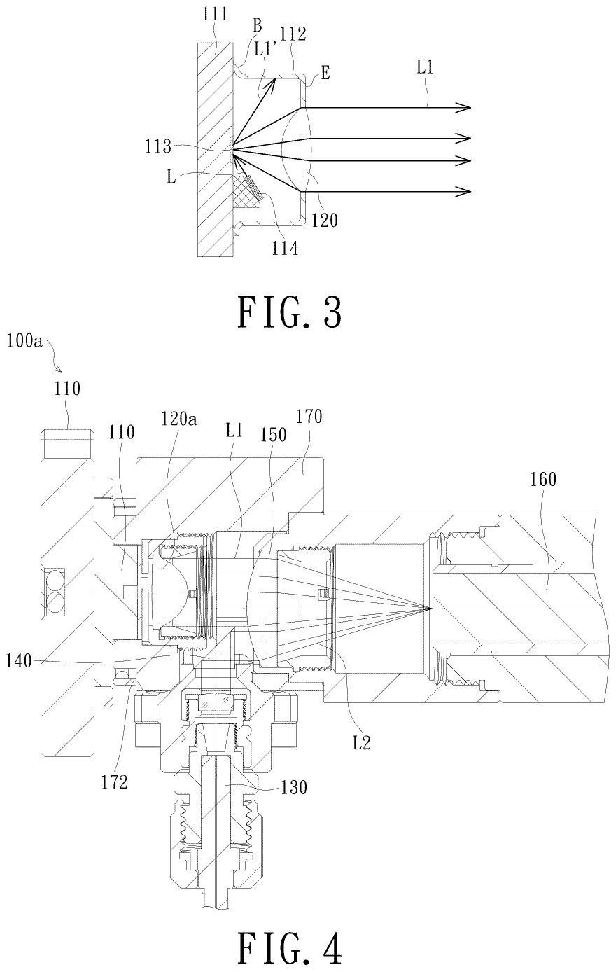

FIG. 1 is a schematic diagram of a laser coupling device according to an embodiment of the present invention. FIG. 2 is a schematic diagram of a laser light source module in FIG. 1. FIG. 3 is a schematic local cross-sectional diagram of the laser light source module in FIG. 2. FIG. 4 is a schematic cross-sectional diagram of the laser coupling device according to another embodiment of the present invention.

First, refer to FIG. 1, FIG. 2, and FIG. 3. A laser light source module 10 includes a first laser light source 110 (laser light source) and a first light concentrating element 120 (light concentrating element). A laser coupling device 100 includes the laser light source module 10, a first optical transmission element 130, a light guide element 140, a second light concentrating element 150, and a second optical transmission element 160. The first laser light source 110 includes a base 111, a housing part 112, and a light-emitting part 113 (shown in FIG. 3). The housing part 112 is provided with a bottom end B and a light outlet end E opposite to each other. The bottom end B is fixed to the base 111, and the light-emitting part 113 is disposed on the base 111 and is located in the housing part 112. The light-emitting part 113 is suitable for generating first laser beams L1. The first light concentrating element 120 is fixed to the light outlet end E of the housing part 112 or the base 111 and is located on a transmission path of the first laser beams L1. The first optical transmission element 130 is suitable for transmitting second laser beams L2. The light guide element 140 is disposed downstream of an optical path of the first optical transmission element 130. The second light concentrating element 150 is disposed downstream of optical paths of the light guide element 140 and the first light concentrating element 120. The second optical transmission element 160 is located downstream of an optical path of the second light concentrating element 150. The second light concentrating element 150 is suitable for coupling the first laser beams L1 and the second laser beams L2 to the second optical transmission element 160.

Still refer to FIG. 2 and FIG. 3. The first laser light source 110 may include a white laser light source, and the first laser beams L1 are, for example, white laser beams. In detail, the white laser beams have a wider wavelength range than other monochromatic laser beams, so that the second laser beams L2 with various wavelengths can be selected. In this embodiment, the white laser beams may be formed by conversion of blue laser beams. For example, in an embodiment, the first laser light source 110 may further include a laser light source part 114, and the laser light source part 114 is suitable for emitting laser beams L. Further, the laser beams L are for example, blue laser beams, and the light-emitting part 113 may be provided with a material with a wavelength that can convert the laser beams, such as phosphor or phosphor, so that the laser beams L (blue laser beams) are converted into the first laser beams L1 (white laser beams). The laser light source part 114 may include a blue light-emitting chip, but the present invention is not limited thereto. In addition, the present invention does not impose any restrictions on specific means for generating the white laser beams. In this embodiment, the first laser light source 110 includes, for example, a white light laser diode in a TO-CAN package, but other embodiments are not limited thereto.

The first concentrating element 120 in this embodiment can guide the first laser beams L1 to the light guide element 140. Specifically, the first laser beams L1 generated by the light-emitting part 113 are in a slightly divergent state, and the first light concentrating element 120 can converge the first laser beams L1 in the divergent state, so that the first laser beams L1 can be roughly parallel beams or slightly convergent beams and incident on the light guide element 140. The first light concentrating element 120 includes, for example, a biconvex aspheric lens. In detail, because the first light concentrating element 120 is fixed to the light outlet end E of the housing part 112, a distance between the first light concentrating element 120 and the light-emitting part 113 is greatly reduced. Therefore, the first biconvex aspheric lens may be used for the first light concentrating element 120 to greatly shorten a focal length of the first light concentrating element 120, so that the first laser beams L1 can be roughly parallel beams or slightly convergent beams after passing through the first light concentrating element 120. Incidentally, structures of the biconvex aspheric lens (namely, the first light concentrating element 120) shown in FIG. 2 and FIG. 3 are only examples. For example, as shown in FIG. 4, a first light concentrating element 120a of a laser coupling device 100a may be a biconvex aspheric lens, but a shape of the first light concentrating element 120a is different from a shape of the first light concentrating element 120 in FIG. 3. It can be understood that the present invention does not impose more restrictions on a specific structure of the biconvex aspheric lens.

Refer to FIG. 1. The first optical transmission element 130 can guide the second laser beams L2 to the light guide element 140. The first optical transmission element 130 includes, for example, an optical fiber. Further, the optical fiber can be coupled to a second laser light source (not shown in the figure) to transmit the above second laser beams L2 generated by the second laser light source to the light guide element 140. A wavelength of the second laser beam L2 may be different from a wavelength of the first laser beam L1. For example, in an embodiment, the first laser beams L1 may include white laser beams, and the second laser beams L2 may include red laser beams, but the present invention is not limited thereto.

In this embodiment, the light guide element 140 can guide the second laser beams L2 emitting from the first optical transmitting element 130 to the second light concentrating element 150. The light guide element 140 includes, for example, a prism. Further, the light guide element 140 may include a light guide surface S1, a light guide surface S2, and a light guide surface S3 connected with each other. The second laser beams L2 may be incident on the light guide surface S1, and the light guide surface S2 can reflect the second laser beams L2 to the light guide surface S3, so that the second laser beams L2 are emitted from the light guide surface S3. In this embodiment, the light guide surface S1 and the light guide surface S3 may be substantially perpendicular to each other, but the present invention is not limited thereto.

In this embodiment, the second light concentrating element 150 can receive the first laser beams L1 emitting from the first light concentrating element 120 and the second laser beams L2 emitting from the light guide element 140 to converge and couple the first laser beams L1 and the second laser beams L2 to the second optical transmission element 160. The second light concentrating element 150 may include an aspheric lens, such as a biconvex lens, and the second condenser 150 may be made of glass. Incidentally, a focal length of the second light concentrating element 150 is greater than a focal length of the first light concentrating element 120. In addition, because the second light concentrating element 150 needs to enable the first laser beams L1 and the second laser beams L2 to be incident together, a volume of the second light concentrating element 150 may be larger than a volume of the first light concentrating element 120.

The second optical transmission element 160 can transmit the first laser beams L1 and the second laser beams L2 coupled to each other to guide the first laser beams L1 and the second laser beams L2 coupled to each other to emit from the laser coupling device 100. The second optical transmission element 160 includes, for example, an optical fiber.

Compared with the prior art, the first light concentrating element 120 is used for the laser light source module 10 in this embodiment to focus the first laser beams L1 generated by the first laser light source 110. The first light concentrating element 120 is fixed to the light outlet end E of the housing part 112 of the first laser light source 110 to significantly shorten a distance of transmission of the first laser beams L1 from the first laser light source 110 to the first light concentrating element 120. Therefore, the laser light source module 10 in this embodiment can reduce energy loss of the first laser beams L1, thereby improving light utilization efficiency. The laser light source module 10 is used for the laser coupling device 100 in this embodiment, so that the light utilization efficiency can be improved. In addition, because the first light concentrating element 120 is fixed to the housing part 112 of the first laser light source 110 and is not separated from the first laser light source 110, space required for configuring the first light concentrating element 120 can be significantly reduced, and then a volume of the laser coupling device 100 can be effectively reduced.

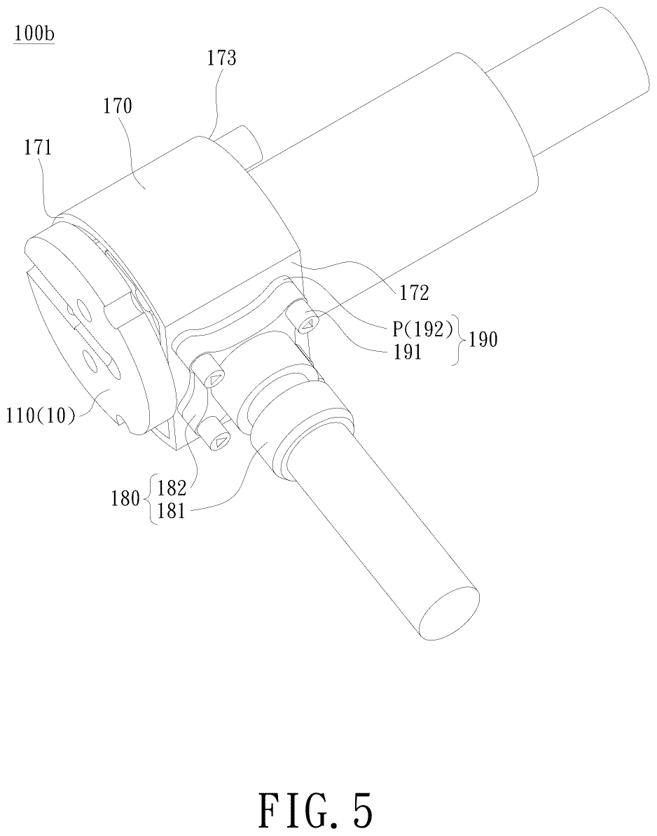

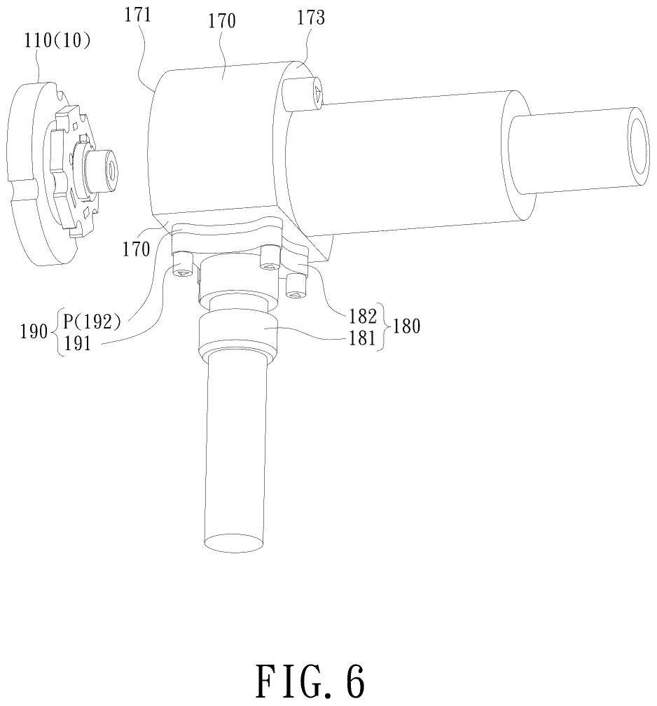

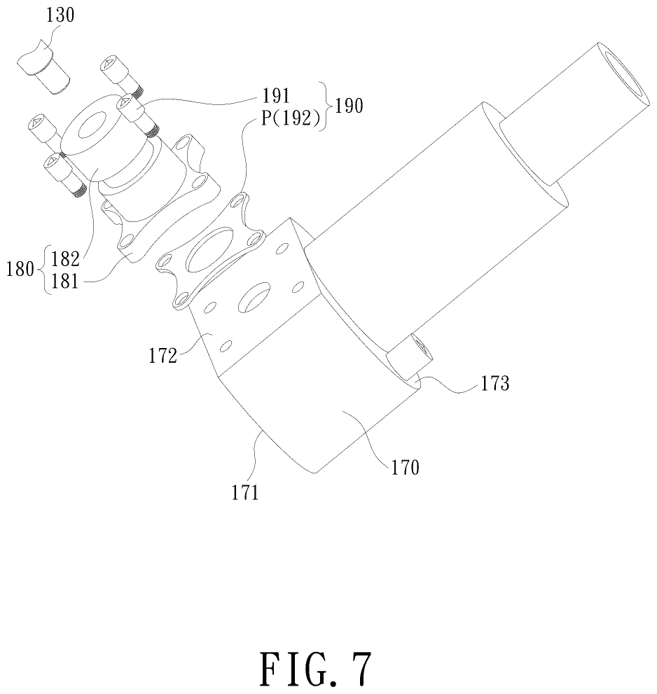

FIG. 5 is a schematic diagram of the laser coupling device according to still another embodiment of the present invention. FIG. 6 is a schematic diagram of separation of a first laser light source from a housing in FIG. 5. FIG. 7 is a schematic exploded diagram of the laser coupling device in FIG. 5 without the first laser light source. A structure and advantages of a laser coupling device 100b in this embodiment are similar to a structure and advantages of the embodiment in FIG. 1, and only differences are described below. First, refer to FIG. 5 and FIG. 6. The laser coupling device 100b may further include a housing 170, an optical transmission base 180, and a calibration component 190. The housing 170 is provided with a first side 171, a second side 172, and a light outlet side 173. The first side 171 is opposite to the light outlet side 173, and the second side 172 is located between the first side 171 and the light outlet side 173. The first laser light source 110 is fixed to the first side 171. Refer to FIG. 5 and FIG. 7. The optical transmission base 180 is provided with an optical transmission part 181 and a locking part 182 connected to each other. The locking part 182 is connected to the second side 172, and the optical transmission part 181 is connected to the locking part 182 and the first optical transmission element 130 (shown in FIG. 7). The calibration component 190 includes a plurality of locking components 191 and a pad 192 (also shown in FIG. 6). The pad 192 is pressed against a position between the second side 172 and the locking part 182, and the locking component 191 passes through the locking part 182 and the pad 192 and extends into the second side 172. Further, still refer to FIG. 5. The light guide element 140 (shown in FIG. 1 and FIG. 4) can be located inside the housing 170 and close to the second side 172. A depth of each locking component 191 extending into the second side 172 is adjusted, to change a force of each locking component 191 pressing against the pad 192. In this way, the first optical transmission element 130 can be slightly tilted relative to the second side 172, thereby slightly changing an angle at which the second laser beams L2 are incident on the light guide element 140.

In addition, the locking component 191 can also fix the optical transmission base 180 to the second side 172 of the housing 170. The locking components 191 in this embodiment may include screws. In detail, the screws can be first screwed in and locked on the second side 172 and then slightly unscrewed out from the second side 172, so that an angle at which the second laser beam L2 (shown in FIG. 1 and FIG. 4) is incident on the light guide element 140 (shown in FIG. 1) can be adjusted. However, the present invention does not limit a specific operation method for the screws. Incidentally, there may be at least four locking components 191 in this embodiment, so that not only the firmness of locking the optical transmission base 180 can be improved but also an incident angle of the second laser beams L2 can be adjusted more accurately. The laser coupling device 100b includes, for example, four locking components 191, but the present invention is not limited thereto.

Still refer to FIG. 5 and FIG. 7. The pad 192 in this embodiment includes, for example, a gasket P. Further, because the gasket P can be designed as an integral structure, the gasket P is easily assembled. The gasket P may be made of a malleable material, for example, the gasket P may be made of rubber, silicone, or metal, but the present invention is not limited thereto. Incidentally, all locking components 191 in this embodiment pass through the gasket P.

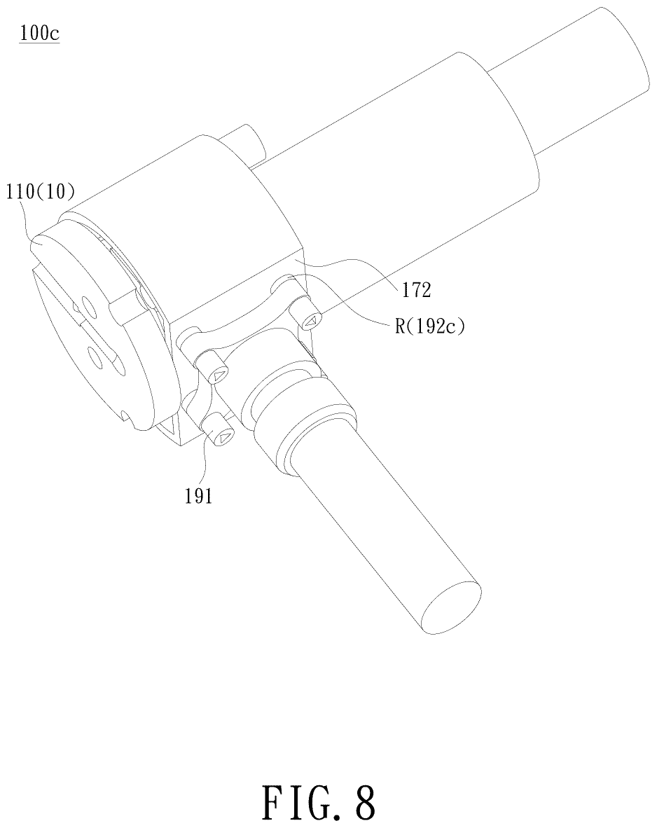

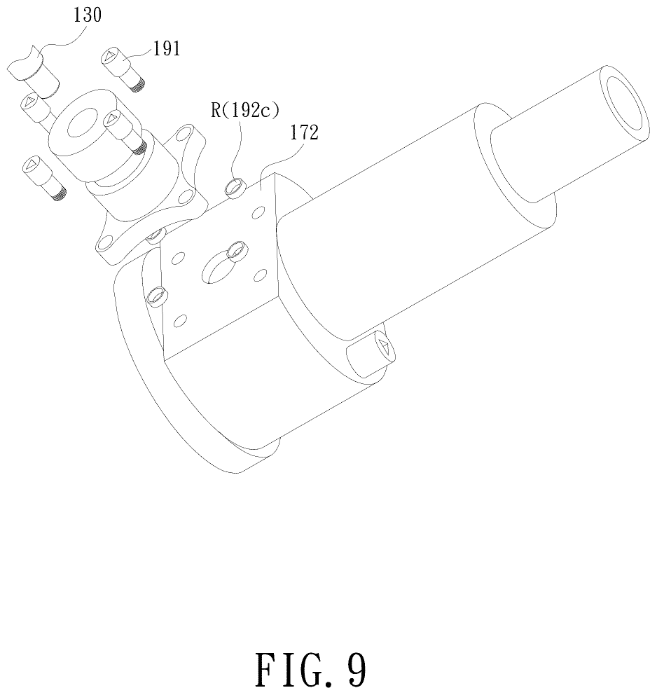

FIG. 8 is a schematic diagram of the laser coupling device according to still another embodiment of the present invention. FIG. 9 is a schematic diagram of separation of the housing, an optical transmission base, a calibration component, and a first optical transmission element in FIG. 8. A structure and advantages of a laser coupling device 100c in this embodiment are similar to a structure and advantages of the embodiment of FIG. 6, and only differences are described below. Still refer to FIG. 8 and FIG. 9. A pad 192c includes, for example, a plurality of pad rings R. In detail, a quantity of the pad rings R is the same as a quantity of the locking components 191, and each locking component 191 passes through each pad ring R and extends into a second side 172. In this way, a force of the pad 192c to push against each locking component 191 can be increased, so that an angle at which the second laser beams L2 (shown in FIG. 1 and FIG. 4) is incident on the light guide element 140 (shown in FIG. 1 and FIG. 4) can be adjusted more easily. Similarly, the pad rings R are made of, for example, rubber, silicone, or metal, but other embodiments are not limited thereto.

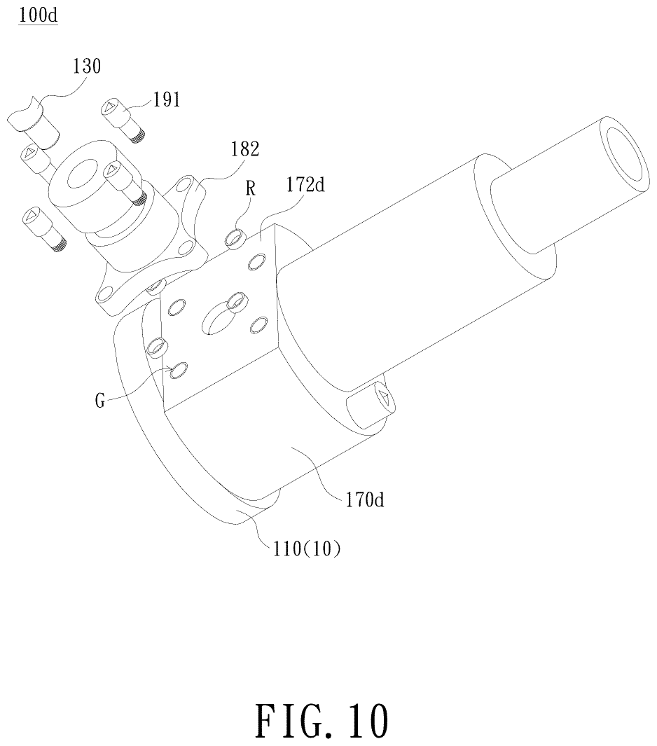

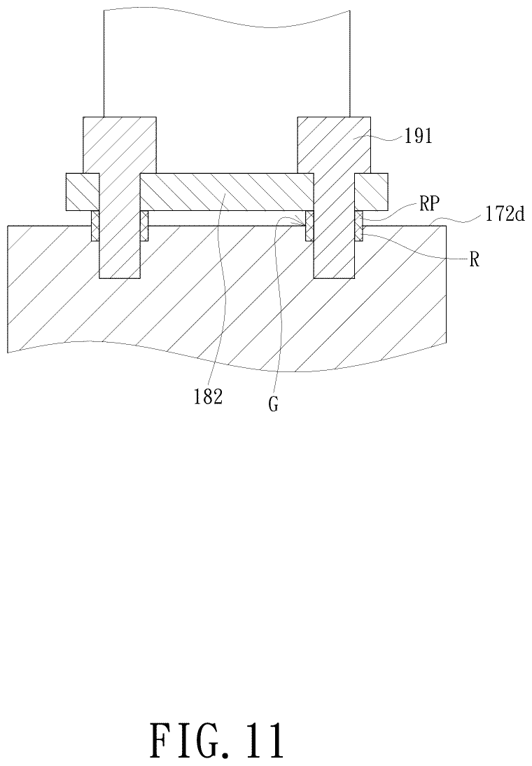

FIG. 10 is a schematic diagram of separation of the housing, the optical transmission base, the calibration component, and the first optical transmission element of the laser coupling device according to another embodiment of the present invention. FIG. 11 is a schematic partial cross-sectional diagram of assembly of the housing, the optical transmission base, and the calibration component in FIG. 10. A structure and advantages of a laser coupling device 100d in this embodiment are similar to a structure and advantages of the embodiment of FIG. 9, and only differences are described below. Refer to FIG. 10 and FIG. 11. A second side 172d of a housing 170d may be provided with a plurality of grooves G. Pad rings R are disposed in the grooves G respectively, and a local part RP of each pad ring R protrudes from each groove G. A locking part 182 is pressed against the local part RP of the pad ring R, so that the pad ring R can be more firmly fixed to the second side 172d when pressed by the locking part 182. It can be understood that a quantity of the grooves G is the same as a quantity of the pad rings R.

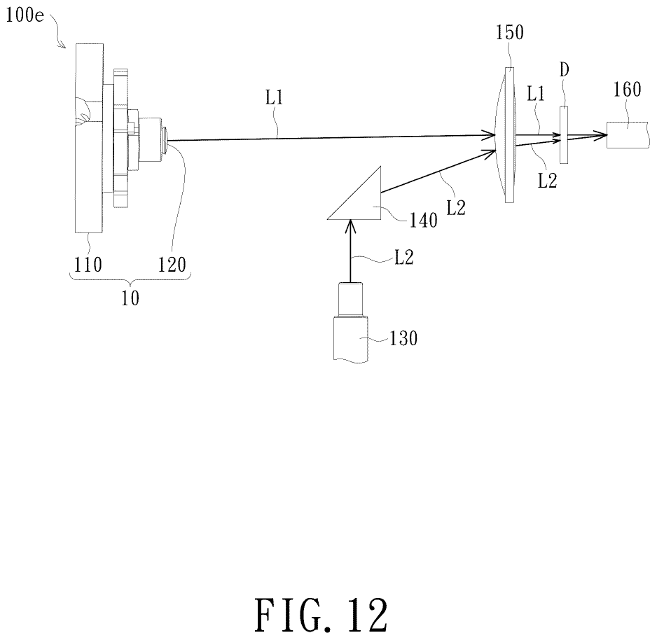

FIG. 12 is a schematic diagram of the laser coupling device according to still another embodiment of the present invention. A structure and advantages of a laser coupling device 100e in this embodiment are similar to a structure and advantages of the embodiment in FIG. 1, and only differences are described below. Refer to FIG. 12. The laser coupling device 100e may further include a light homogenizer D. The light homogenizer D is disposed between a second light concentrating element 150 and a second optical transmission element 160. In detail, the light homogenizer D can block stray light of the first laser beams L1 and homogenize light spots of the first laser beams L1, so that the first laser beams L1 can be more uniformly and concentratedly incident on the second optical transmission element 160. In this way, the light receiving effect of the second optical transmission element 160 can be effectively improved, thereby further enhancing light utilization efficiency of the laser coupling device 100e. Incidentally, the light homogenizer D may include an atomized quartz light homogenizer, and in one embodiment, a thickness of the atomized quartz light homogenizer may be approximately 1 mm, but the present invention does not impose many restrictions on this.

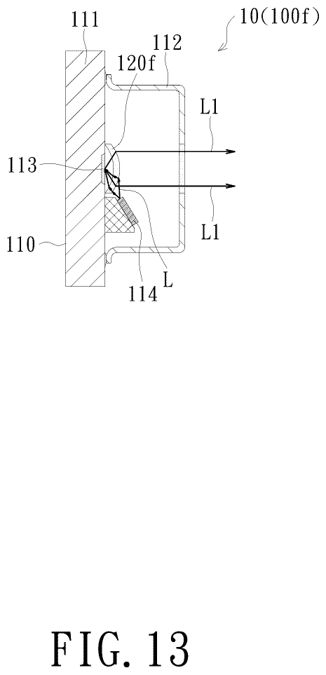

FIG. 13 is a schematic partial cross-sectional diagram of the laser light source module of the laser coupling device according to another embodiment of the present invention. A structure and advantages of a laser coupling device 100f and a laser light source module 10f in this embodiment are similar to a structure and advantages of the embodiment in FIG. 1, and only differences are described below. Refer to FIG. 13. A first light concentrating element 120f is fixed to a base 111 and covers a light-emitting part 113. A laser light source part 114 is fixed to the base 111 of a first laser light source 110 and is suitable for emitting laser beams L towards the first light concentrating element 120f. The first light concentrating element 120f is suitable for converging the laser beams L to the light-emitting part 113, and the light-emitting part 113 is suitable for converting the laser beams L into first laser beams L1. Specifically, the laser beams L can be focused onto the light-emitting part 113 through the first light concentrating element 120f, and a distance between the first light concentrating element 120f and the light-emitting part 113 is significantly reduced, so that more first laser beams L1 emitted from the light-emitting part 113 are incident on the first light concentrating element 120f, thereby improving light utilization efficiency. In addition, because the laser beams L can be more concentratedly incident on the light-emitting part 113 through the first light concentrating element 120f, and the distance between the first light concentrating element 120f and the light-emitting part 113 is greatly reduced, the first laser beams L1 can also be approximate to parallel beams and emitted from a housing part 112. In this way, scattered light spots generated by reflection of the first laser beams L1 inside the housing part 112 can be reduced or eliminated, thereby reducing the generation of stray light. For example, the light homogenizer D in FIG. 12 can be omitted for the laser coupling device 100f in this embodiment, but other embodiments are not limited thereto. In this embodiment, the first light concentrating element 120f may include a concave-convex lens, but the present invention is not limited thereto.

In summary, the first light concentrating element is used for the laser light source module in the present invention to focus the first laser beams generated by the first laser light source. The first light concentrating element is fixed to the light outlet end of the housing part of the first laser light source, to significantly shorten a distance of transmission of the first laser beams from the first laser light source to the first light concentrating element. Therefore, the laser light source module in the present invention can reduce energy loss of the first laser beams, thereby improving light utilization efficiency. The laser light source module is used for the laser coupling device in the present invention, so that the light utilization efficiency can be improved. In addition, because the first light concentrating element is fixed to the housing part of the first laser light source and is not separated from the first laser light source, space required for configuring the first light concentrating element can be significantly reduced, and then a volume of the laser coupling device can be effectively reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laser coupling device, comprising:
a laser light source module, comprising a first laser light source and a first light concentrating element, wherein the first laser light source comprises a base, a housing part, and a light-emitting part, the housing part is provided with a bottom end and a light outlet end opposite to each other, the bottom end is fixed to the base, the light-emitting part is disposed on the base and located inside the housing part, the light-emitting part is suitable for generating first laser beams, and the first light concentrating element is fixed to the light outlet end of the housing part or the base and is located on a transmission path of the first laser beams;
a first optical transmission element, suitable for transmitting second laser beams;
a light guide element, disposed downstream of an optical path of the first optical transmission element;
a second light concentrating element, disposed downstream of optical paths of the light guide element and the first light concentrating element; and
a second optical transmission element, located downstream of an optical path of the second light concentrating element, wherein the second light concentrating element is suitable for coupling the first laser beams and the second laser beams to the second optical transmission element.

2. The laser coupling device according to claim 1, wherein the first light concentrating element comprises a biconvex aspheric lens.

3. The laser coupling device according to claim 1, further comprising a housing, an optical transmission base, and a calibration component, wherein
the housing is provided with a first side, a second side, and a light outlet side, the first side is opposite to the light outlet side, the second side is located between the first side and the light outlet side, the first laser light source is fixed to the first side, the optical transmission base is provided with an optical transmission part and a locking part connected to each other, the locking part is connected to the second side, and the optical transmission part is connected to the locking part and the first optical transmission element; and
the calibration component comprises a plurality of locking components and a pad, the pad is pressed between the second side and the locking part, and the locking components pass through the locking part and the pad and extend into the second side.

4. The laser coupling device according to claim 3, wherein the pad comprises a gasket.

5. The laser coupling device according to claim 4, wherein the gasket is made of rubber, silicone, or metal.

6. The laser coupling device according to claim 3, wherein the pad comprises a plurality of pad rings.

7. The laser coupling device according to claim 6, wherein the second side of the housing is provided with a plurality of grooves, the pad rings are respectively disposed in the grooves, a local part of each of the pad rings protrudes from each of the grooves, and the locking part presses against the local parts of the pad rings.

8. The laser coupling device according to claim 6, wherein the pad rings are made of rubber, silicone, or metal.

9. The laser coupling device according to claim 3, wherein there are at least four locking components.

10. The laser coupling device according to claim 1, wherein the light guide element comprises a prism.

11. The laser coupling device according to claim 1, wherein the first laser light source comprises a white laser light source.

12. The laser coupling device according to claim 1, further comprising a light homogenizer, wherein the light homogenizer is disposed between the second light concentrating element and the second optical transmission element.

13. The laser coupling device according to claim 1, wherein the first light concentrating element is fixed to the base and covers the light-emitting part, the first laser light source further comprises a laser light source part fixed to the base and suitable for emitting laser beams towards the first light concentrating element, the first light concentrating element is suitable for converging the first laser beams to the light-emitting part, and the light-emitting part is suitable for converting the laser beams into the first laser beams.

14. A laser light source module, comprising:
a laser light source, comprising a base, a housing part, and a light-emitting part, wherein the housing part is provided with a bottom end and a light outlet end opposite to each other, the bottom end is fixed to the base, the light-emitting part is disposed on the base and located inside the housing part, and the light-emitting part is suitable for generating laser beams; and
a light concentrating element, fixed to the light outlet end of the housing part and located on a transmission path of the laser beams.
